(19) United States
(12) Patent Application Publication
(10) Pub. No.: US 2014/0182707 A1
(43) Pub. Date: Jul. 3, 2014

(54) DRAIN APPARATUS

(71) Applicant: HYUNDAI MOTOR COMPANY, Seoul (KR)

(72) Inventors: Jin Won HONG, Yongin-si (KR); Kwang Sik YANG, Gunpo-si (KR); Jun Sik PARK, Seoul (KR); Hyung Ick KIM, Gunpo-si (KR)

(73) Assignee: Hyundai Motor Company, Seoul (KR)

(21) Appl. No.: 13/865,817

(22) Filed: Apr. 18, 2013

(30) Foreign Application Priority Data
Dec. 27, 2012 (KR) 10-2012-0154473

(51) Int. Cl. B60K 11/02

(52) U.S. Cl. CPC B60K 11/02
USPC 137/312

(57) ABSTRACT

A drain apparatus may include a storage chamber that has a through-hole through which a coolant, which leaks through a mechanical seal sealing an impeller shaft of a water pump in a vehicle, flows inside, and stores the coolant flowing inside via the through-hole, and a discharge tube that may be disposed vertically through a bottom of the storage chamber, with an upper end thereof extending to the inside of the storage chamber such that a height thereof may be positioned between a top and the bottom of the storage chamber.

### CROSS-REFERENCE TO RELATED APPLICATION

The present application claims priority to Korean Patent Application No. 10-2012-0154473, filed on Dec. 27, 2012, the entire contents of which is incorporated herein for all purposes by this reference.

### BACKGROUND OF THE INVENTION

1. Field of the Invention

The present invention relates to a drain apparatus in a water pump for a vehicle which prevents an influence on other parts of a vehicle by storing a leaking coolant and discharging it downward to the outside of the vehicle.

2. Description of Related Art

Since heat keeps generated during the operation of an engine of a vehicle, the engine is cooled by circulating a coolant with a water pump. In the water pump, an impeller carries the coolant to the engine by rotating and a mechanical seal seals an impeller shaft carrying the coolant and allows an appropriate amount of coolant to leak, thereby performing lubrication too. Therefore, a predetermined amount of coolant leaks inevitably and it is important to prevent the leaking coolant from flowing outside.

FIG. 1 is a view showing a drain apparatus of a water pump 1000′ of the related art, a coolant leaking through a mechanical seal 30 is stored in a storage chamber 50 via a through-hole 70 (along the path of arrows shown by dotted lines), changed its phase into gas by heat from an engine, and then evaporated via the through-hole 70 and a drain hole 60 (along the path of arrows shown by solid lines). However, the coolant stored in the storage chamber 50 flows outside through the drain hole 60 and is scattered by a pulley of the water pump 1000′ onto the front of the engine to be exposed, when the vehicle rapidly decelerates, goes up on a slope, or turns, with the coolant in a liquid state before evaporating, which causes bad visual effect.

In order to solve the problem, KR 10-2007-0107865 A, titled “a drain chamber sealing coin setting structure for a vehicle's engine cooling system and the method” discloses a structure with a coin-shaped sealing member mounted on the front end of a drain chamber and a method of sealing a drain chamber with a low-cost coin-shaped sealing member by mounting a coin-shaped sealing member on a drain chamber, through die-casting a water pump body including the drain chamber, applying a sealant to the coin-shaped sealing member, and forcibly fitting the coin-shaped sealing member, but the die-casting is performed and the forcible fitting of the sealing coin is performed, therefore the process is complicated and the structure is also complicated.

Therefore, it is required to develop a drain apparatus that prevents a coolant from being exposed to the front of an engine even under bad driving conditions of a vehicle and even with a simple structure.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a drain apparatus that prevents a coolant from being exposed to the front of an engine even under bad driving conditions of a vehicle and even with a simple structure.

In an aspect of the present invention, a drain apparatus may include a storage chamber that may have a through-hole through which a coolant, which leaks through a mechanical seal sealing an impeller shaft of a water pump in a vehicle, flows inside, and stores the coolant flowing inside via the through-hole, and a discharge tube that is disposed vertically through a bottom of the storage chamber, with an upper end thereof extending to the inside of the storage chamber such that a height thereof is positioned between a top and the bottom of the storage chamber.

The storage chamber is disposed under an impeller shaft.

The storage chamber is a closed space with the through-hole at the top thereof and the discharge tube at the bottom thereof.

The discharge tube protrudes outside from the bottom of the storage chamber.

The coolant stored in the storage chamber flows through the upper end of the discharge tube and is discharged outside through the discharge tube.

The coolant stored in the storage chamber is evaporated and discharged in a gas state through the through-hole and the discharge tube.

The through-hole is formed in a vertical direction.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a drain apparatus of the related art.

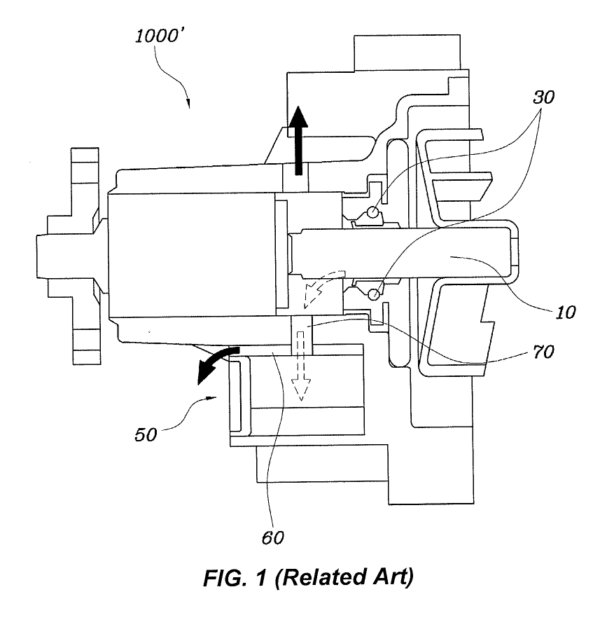

FIG. 2 is a view showing a drain apparatus according to an exemplary embodiment of the present invention.

FIG. 3 is a view showing the part A of FIG. 2 in detail.

FIG. 4 is view showing the drain apparatus mounted on a vehicle.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A drain apparatus according to exemplary embodiments of the present invention is described hereafter with reference to the accompanying drawings.

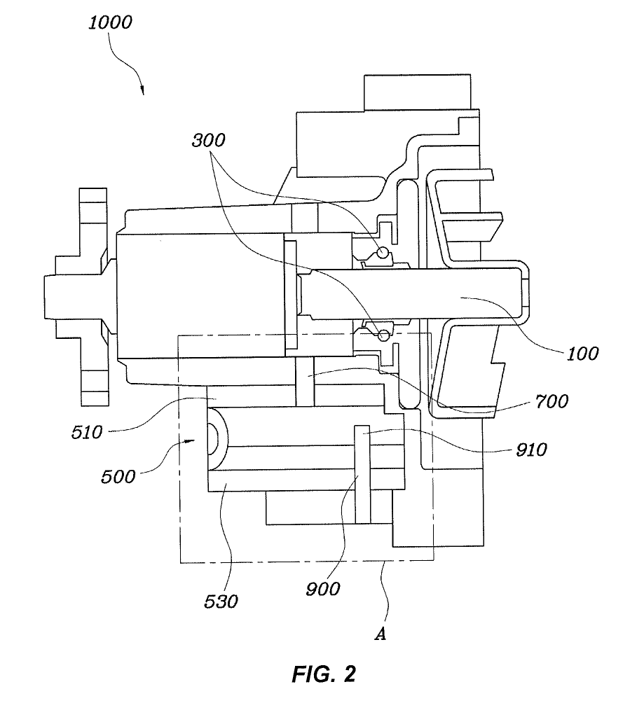

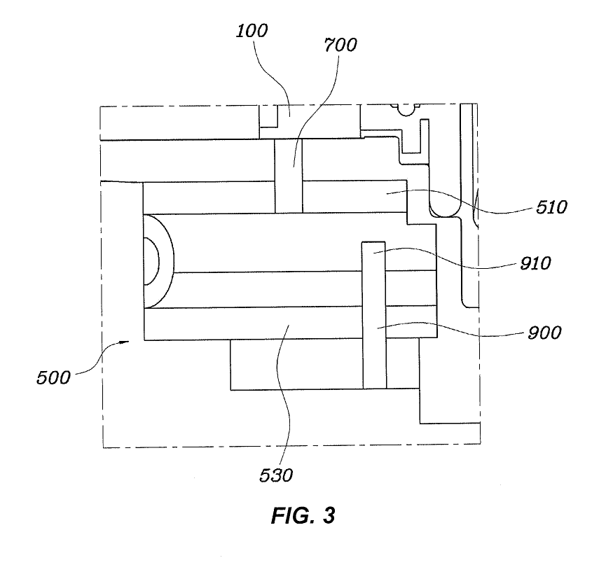

FIG. 2 shows a drain apparatus according to an exemplary embodiment of the present invention and FIG. 3 is a view showing the part A of FIG. 2 in detail. The drain apparatus includes: a storage chamber 500 that has a through-hole 700 through which a coolant, which leaks through a mechanical seal 300 sealing an impeller shaft 100 of a water pump 1000 of a vehicle, flows inside, and stores the coolant flowing inside via the through-hole 700, and a discharge tube 900 that is disposed vertically at the bottom 530 of the storage chamber 500, with the upper end 910 extending to the inside of the storage chamber 500 such that the height is positioned between the top 510 and the bottom 530 of the storage chamber 500.

The storage chamber 500, which is a closed space with a through-hole 700 at the top 510 and a discharge tube 900 at the bottom 530, is disposed under the impeller shaft 100. A coolant leaking through the mechanical seal 400 is stored in the storage chamber 500 via the through-hole 700.

The discharge tube 900 is disposed at the bottom 530 of the storage chamber 500 instead of closing the portion where a drain hole is formed to prevent careening due to inertia in the related art. The discharge tube 900 is disposed through the bottom 530 of the storage chamber 500, the upper end 910 of the discharge tube 900 is lower than the height of the storage chamber 500, but is disposed as close as possible to the top 510 of the storage chamber 500. The discharge tube 900 protrudes outside from through the bottom 530 of the storage chamber 500, therefore a coolant flows to the upper end 910 of the discharge tube 900 by careening of a coolant due to inertia, and the coolant is discharged under the engine by the discharge tube 900.

Without careening due to inertia, the coolant stored in the storage chamber 500 changes its phase into a gas and is evaporated and discharged in a gas state via the through-hole 700 and the discharge tube 900.

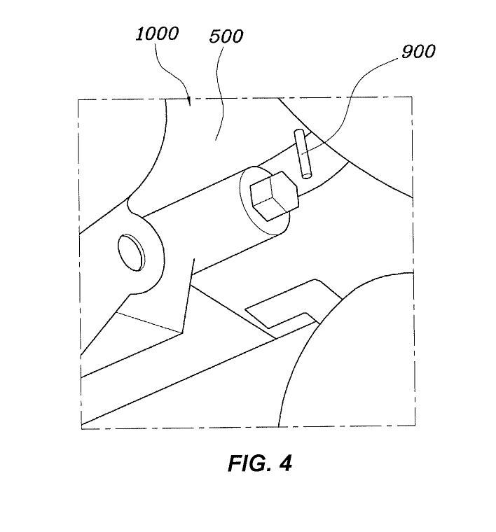

FIG. 4 shows a drain apparatus practically mounted on a vehicle. According to a test, a coolant flows outside even when the amount of the coolant stored in the storage chamber 500 is 1 cc in a drain apparatus of the related art, but a coolant leaked under the condition of 4 cc in the drain apparatus according to an exemplary embodiment of the present invention. Therefore, the present invention has an effect of four-times prevention of leakage in comparison to the related art and the coolant little leaks even under the conditions that a vehicle rapidly decelerates, goes up on a slope, or turns, which means there is an effect of preventing the coolant from being exposed outside.

Further, even if the coolant leaks outside, the path of leaking is changed to flow under the engine, not flowing to the front of the engine, so the leaking coolant is little seen from the outside.

According to a drain apparatus with the structure described above, a coolant is further prevented from being exposed in comparison to the related art and little leaks even under the condition that a vehicle rapidly decelerates, goes up on a slope, or turns, which means there is an effect of preventing the coolant from being exposed outside.

Further, even if the coolant leaks outside, the path of leaking is changed to flow under the engine, not flowing to the front of the engine, so the leaking coolant is little seen from the outside.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A drain apparatus comprising:
a storage chamber that has a through-hole through which a coolant, which leaks through a mechanical seal sealing an impeller shaft of a water pump in a vehicle, flows inside, and stores the coolant flowing inside via the through-hole; and
a discharge tube that is disposed vertically through a bottom of the storage chamber, with an upper end thereof extending to the inside of the storage chamber such that a height thereof is positioned between a top and the bottom of the storage chamber.

2. The drain apparatus of claim 1, wherein the storage chamber is disposed under an impeller shaft.

3. The drain apparatus of claim 1, wherein the storage chamber is a closed space with the through-hole at the top thereof and the discharge tube at the bottom thereof.

4. The drain apparatus of claim 1, wherein the discharge tube protrudes outside from the bottom of the storage chamber.

5. The drain apparatus of claim 1, wherein the coolant stored in the storage chamber flows through the upper end of the discharge tube and is discharged outside through the discharge tube.

6. The drain apparatus of claim 1, wherein the coolant stored in the storage chamber is evaporated and discharged in a gas state through the through-hole and the discharge tube.

7. The drain apparatus of claim 1, wherein the through-hole is formed in a vertical direction.
